(19) United States
(12) Patent Application Publication
(10) Pub. No.: US 2016/0145925 A1
(43) Pub. Date: May 26, 2016

(54) Magnetic Hooking Device for Movable Parts of Furniture

(71) Applicant: ARTURO SALICE S.P.A., Novedrate (Como) (IT)

(72) Inventor: Luciano Salice, Carimate (como) (IT)

(21) Appl. No.: 14/900,647

(22) PCT Filed: Jan. 15, 2015
(86) PCT No.: PCT/EP2015/050625

§ 371 Date: Dec. 22, 2015

(30) Foreign Application Priority Data
Jan. 22, 2014 (IT) MI2014A 000076

(51) Int. Cl. E05F 5/06; A47B 88/16

(52) U.S. Cl. CPC E05F 5/06; A47B 88/16

(57) ABSTRACT

The magnetic hooking device (10) is applicable to a movable part of a piece of furniture and it is hookable to a magnetic opening and/or closing device that is applicable to a fixed part of the piece of furniture; the hooking device (10) comprises a ferromagnetic element (11) with which at least one permanent magnet (12) is magnetically connected. The ferromagnetic element (11) is arranged together with the at least one permanent magnet (12) in a housing body (13) in such a manner as to be magnetically connectable with the opening and/or closing device.

### BACKGROUND OF THE INVENTION

The invention concerns a magnetic hooking device for movable parts of furniture and the like, particularly a magnetic hooking device that is applicable to a door or drawer of a piece of furniture and hookable to a magnetic opening and/or closing device that is applicable to a fixed part of the piece of furniture.

### STATE OF THE ART

The use of furniture having movable parts, such as doors or drawers without handles or similar gripping means, is known in the furnishings sector. In such cases, for the purposes of opening the door or drawer, the furniture pieces must be provided with suitable opening means that are lockable, and following a user's light push on a closed door or drawer, the opening means is released and generates a movement of the door or drawer in the opening direction for a first tract that is sufficient for the user to grasp and then open them completely.

Opening means of this type are often in the form of a magnetic opening and/or closing device, for example as known from patent no. WO 2008/031814, arranged on a wall of the furniture piece, said device comprising a box-like body in which a fixed permanent magnet and a releasable slider are arranged, the slider being movable between an inserted position and an extracted position through the action of a spring acting in the opening direction and it can be locked in a releasable manner in the inserted position.

A plate made of ferromagnetic material is normally provided on the door or drawer of the furniture piece. The plate is magnetically attachable to the permanent magnet of the above-mentioned device in the closed position of the movable part of the furniture piece, so as to retain it in that position.

In some cases, however, a solution such as this does not ensure a force sufficient to retain the door or drawer, with the resulting risk that they may be released unwantedly, moving into the open position. Specifically, this can happen in the case of excessively heavy weights of the parts for specific configurations of the furniture and of the movable parts thereof, as well as a result of machining tolerances or clearances or even following adjustments of the same parts.

There is thus a need to achieve a greater retaining force for retaining the doors or drawers, so that the same force can be sufficient even in the case of specific configurations or subsequent adjustments of the movable parts of the furniture.

### OBJECTS OF THE INVENTION

The principal object of the present invention is therefore that of providing a magnetic hooking device for movable parts of furniture or the like, particularly for doors or drawers, and that is applicable in a simple manner to the doors or drawers and that makes it possible to achieve a high magnetic retaining force for these same doors or drawers when they are hooked to a magnetic opening and/or closing device of a known type.

A further object is to provide a magnetic hooking device for hooking movable parts of furniture or the like, which is configured in such a manner as to enable effectiveness of the retaining force also in the case of specific configurations or subsequent adjustments of the same movable parts.

### BRIEF DESCRIPTION OF THE INVENTION

The above is achievable by means of a magnetic hooking device applicable to a movable part of a furniture piece and hookable to a magnetic opening and/or closing device that is applicable to a fixed part of the piece of furniture, the hooking device comprising a ferromagnetic element characterized in that it comprises at least one permanent magnet magnetically connected with said ferromagnetic element, said ferromagnetic element being arranged together with said at least one permanent magnet in a housing body in such a manner as to be magnetically connectable with said opening and/or closing device.

Further characteristics of the present invention are defined in the claims herein below.

### BRIEF DESCRIPTION OF THE DRAWINGS

The characteristics and advantages of the present invention will emerge more clearly in the following description of a preferred, but non-limiting embodiment of the magnetic hooking device for hooking movable parts of furniture, with reference to the attached figures, of which:

FIG. 1 is a longitudinal sectional view of the magnetic hooking device along a plane passing through the axis of the housing body; and

FIG. 2 is an exploded view of the magnetic hooking device of FIG. 1.

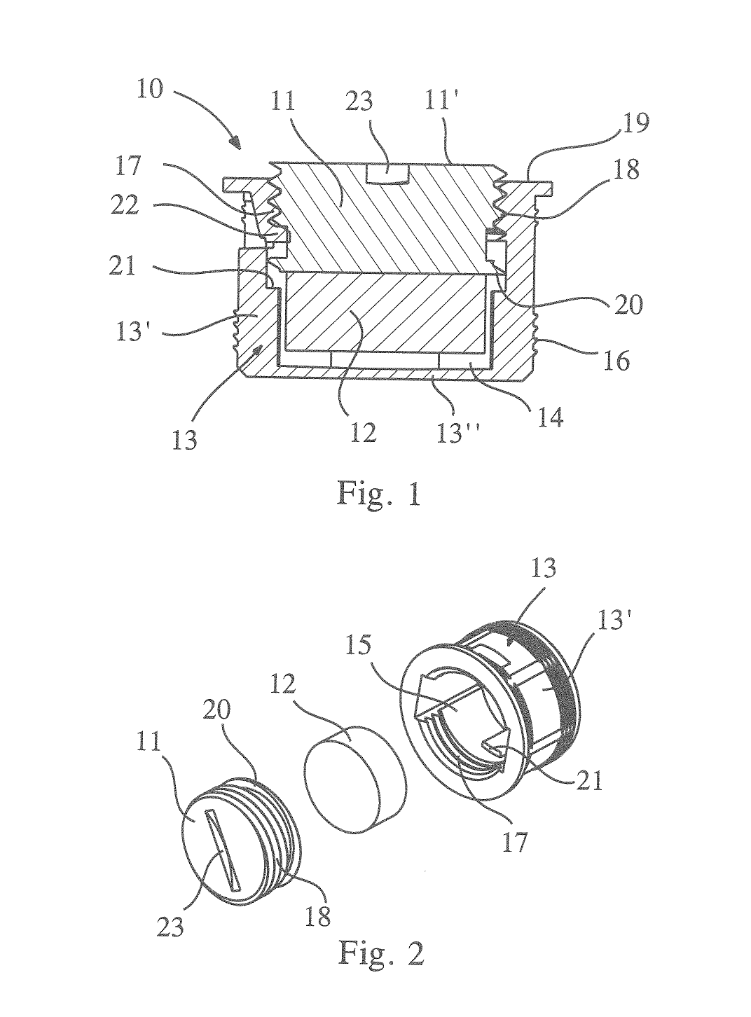

### DETAILED DESCRIPTION OF THE INVENTION

The magnetic hooking device according to the present invention is configured to be applicable particularly to a movable part of a piece of furniture, for example a door or a drawer or the like, and it is hookable to a magnetic opening and/or closing device that is applicable to a fixed part of the furniture piece.

A magnetic opening and/or closing device of the type being considered herein is illustrated for example in patent application no. WO 2008/031814 filed by the same Applicant. This closing and opening snap device of the magnetic ratchet type externally has a tubular shape and may be inserted in a suitable seat onto a wall of a piece of furniture so as to be able to interact with a moveable closing element, for example a furniture door or the front of a drawer. On one end of the device, a slider and a magnetic element are arranged reciprocally coaxial and protruding from an abutting plane of the piece of furniture. The magnetic element surrounds the slider and is free to be axially displaced and with its front part it may adhere to a ferromagnetic material plate fixed to the moveable closing element, so as to keep it closed. The slider may turn about its axis and slide longitudinally for a longer tract with respect to that of the magnetic element. In its rear part, the slider is provided with a control or actuation device for the rotation of the slider itself, needed to displace it between the inserted and extracted positions. This control device is of the type used for ball-point pens.

With reference to the attached figures, the hooking device, which is indicated in its entirety by reference number 10, generally comprises a ferromagnetic element 11 with which at least one permanent magnet 12 is magnetically connected; the ferromagnetic element 11 and the at least one permanent magnet 12 joined to it are arranged in a housing body 13 in such a manner that the ferromagnetic element 11 is magnetically connectable with the opening and/or closing device, in particular with a permanent magnet or a part of the opening device made of magnetized ferromagnetic material.

In particular, the permanent magnet 12 is disposed and configured to generate a magnetomotive force which adds in series to the magnetomotive force generated by the opening and/or closing device.

The permanent magnet 12 and the ferromagnetic element 11 are in contact with each other.

The contact surface between the permanent magnet 12 and the ferromagnetic element 11 lies in a plane orthogonal to the magnetization axis of the permanent magnet 12.

Preferentially, the ferromagnetic element 11, together with the at least one magnet 12, is adjustably arranged in the housing body 13 and for this purpose, the housing body 13 has an internal seat 14 for the at least one permanent magnet 12 being of dimensions suitable for allowing an adjusting movement of the permanent magnet 12 together with the ferromagnetic element 11.

In the preferred embodiment illustrated herein, the housing body 13 is shaped in the form of a cup having a peripheral tubular wall 13′ extending along a longitudinal axis and that is closed at one end by a bottom wall 13″. The peripheral wall 13′ ends at the opposite end in a front opening 15 for inserting the ferromagnetic element 11, through which the ferromagnetic element 11 protrudes so as to be magnetically connectable with the opening and/or closing device.

More specifically, oriented with its magnetization axis parallel to the longitudinal axis of the housing body, the permanent magnet 12 is magnetically connected with the ferromagnetic element 11 on a rear side thereof facing the bottom wall 13″, so as to be contained in the housing body 13 and thus protected from possible impacts or damage.

In particular, the housing body 13 is configured for insertion in a seat afforded within the thickness of a door or a front panel of a drawer on an internal side thereof facing the fixed part or body of a piece of furniture. Specifically, the housing body 13 must be inserted in such a manner that front opening 15 thereof is facing the inside of the piece of furniture.

For the purpose of ensuring secure fastening of the housing body 13 within the seat in the door, the body 13 is preferably forcibly press-fitted in the above-mentioned seat and/or a suitable fastening means is provided, for example in the form of annular teeth 16 formed on the outside of the peripheral wall 13′ and designed for engagement in the material of the internal surface of the seat in the door or drawer. Preferentially, for the purposes of the above-mentioned adjustment of the ferromagnetic element 11, the peripheral wall 13′, at the front opening 15, and the ferromagnetic element 11 have reciprocal engaging means conformed for allowing an adjustment of the ferromagnetic element 11 along the longitudinal axis of the peripheral wall 13′ of the housing body 13.

In the most preferred embodiment illustrated herein, the above-mentioned reciprocal engaging means are conformed as threads 17, 18 respectively formed on an internal side of the peripheral wall 13′ and on an external side of the ferromagnetic element 11.

Owing to the above-mentioned adjustment means, the ferromagnetic element 11 is adjustably movable in the housing body 13 between a retracted position, in which the front surface 11 of the same element is flush with the front surface 19 of the housing body 13, and an extracted position, in which the element 11 partially protrudes from the housing body 13 in a frontal direction towards the inside of the piece of furniture.

For the purpose of preventing complete disengagement of the element 11 from the housing body 13 on one hand, and the permanent magnet 12 from breaking through the bottom wall 13″ on the other hand, the ferromagnetic element 11 and the housing body 13 preferentially have stop means that are engageable with each other for limiting the movement of the ferromagnetic element 11 between the retracted position and the extracted position.

In the preferred solution illustrated herein, the stop means comprises a lip 20 that protrudes radially at the rear part of the ferromagnetic element 11. Said lip 20, in the retracted position of the ferromagnetic element 11, comes into contact with shoulder surfaces 21 afforded inside the housing body 13, whereas in the extracted position of the ferromagnetic element 11, it comes into contact with a stop tab 22. For the purposes of assembly of the device, the stop tab 22 is elastically flexible in a radial direction during insertion of the ferromagnetic element 11 so as to enable the lip 20 to pass beyond the tab 22 and thus position itself between the shoulder surfaces 21 and the stop tab 22.

For adjustment purposes, the ferromagnetic element 11 preferentially comprises a gripping means 23 that can be actuated manually or by means of a tool, such as a cut or groove 23, for adjustably moving the same ferromagnetic element 11.

It is evident from the above description that the magnetic hooking device according to the invention can be applied simply to the doors or drawers of furniture, and owing to the presence of the at least one permanent magnet, it makes it possible to achieve a high magnetic retaining force for retaining the doors or drawers when they are attached to a magnetic opening and/or closing device of a known type.

Furthermore, owing to the fact that adjustment of the ferromagnetic element is possible, the magnetic hooking device according to the invention enables the user to find a position of the element that is such as to achieve efficacy of the retaining force even in the case of specific configurations or adjustments of the movable parts of a piece of furniture.

The magnetic hooking device according to the invention is susceptible to modifications and variants falling within the scope of the inventive concept. Moreover, the structural details may be replaced with technically equivalent elements.

1. A magnetic hooking device (10) applicable to a movable part of a piece of furniture and hookable to a magnetic opening and/or closing device that is applicable to a fixed part of the piece of furniture, the hooking device (10) comprising a ferromagnetic element (11) characterized in that it comprises at least one permanent magnet (12) magnetically connected with said ferromagnetic element (11), said ferromagnetic element (11) being arranged together with said at least one permanent magnet (12) in a housing body (13) in such a manner as to be magnetically connectable with said magnetic opening and/or closing device, said ferromagnetic element (11) being adjustably arranged in said housing body (13), the housing body (13) having an internal seat (14) for said at least one permanent magnet (12) being of dimensions suitable for allowing an adjusting movement of the permanent magnet (12) together with said ferromagnetic element (11).

2. The magnetic hooking device (10) according to claim 1, characterized in that said housing body (13) is shaped in the form of a cup having a peripheral tubular wall (13′) extending along a longitudinal axis, said peripheral wall (13′) of the housing body (13) ending in a front opening (15) for inserting said ferromagnetic element (11), through which the same ferromagnetic element (11) protrudes so as to be magnetically connectable with said opening and/or closing device.

3. The magnetic hooking device (10) according to claim 2, characterized in that said peripheral wall (13′), at said front opening (15), and said ferromagnetic element (11) have reciprocal engaging means conformed for allowing an adjustment of said ferromagnetic element (11) along said longitudinal axis of the peripheral wall (13′) of the housing body (13).

4. The magnetic hooking device (10) according to claim 3, characterized in that said reciprocal engaging means are conformed as threads (17, 18).

5. The magnetic hooking device (10) according to claim 3, wherein said ferromagnetic element (11) is adjustably movable in said housing body (13) between a retracted position and an extracted position, characterized in that said ferromagnetic element (11) and said housing body (13) have stop means (20, 21, 22) that are engageable with each other for limiting the movement of said ferromagnetic element (11) between said retracted position and said extracted position.

6. The magnetic hooking device (10) according to claim 1, characterized in that said ferromagnetic element (11) comprises a gripping means (23) that can be actuated manually or by using a tool for adjustably moving the same ferromagnetic element (11).

7. The magnetic hooking device (10) according to claim 1, characterized in that said permanent magnet (12) is disposed and configured to generate a magnetomotive force which adds in series to the magnetomotive force generated by said magnetic device.

8. The magnetic hooking device (10) according to claim 1, characterized in that said permanent magnet (12) and said ferromagnetic element (11) are in contact with each other.

9. The magnetic hooking device (10) according to claim 8, characterized in that the contact surface between said permanent magnet (12) and said ferromagnetic element (11) lies in a plane orthogonal to the magnetization axis of said permanent magnet (12).

10. The magnetic hooking device (10) according to claim 3, characterized in that the magnetization axis of said permanent magnet (12) is parallel to said longitudinal axis.

11. A combination of a magnetic opening and/or closing device with a hooking device according to claim 1.

12. A piece of furniture comprising a magnetic hooking device (10) in accordance with claim 1, applied to a movable part of a piece of furniture and hookable to a magnetic opening and/or closing device applied to a fixed part of the piece of furniture.
